(19) United States
(12) Patent Application Publication
(10) Pub. No.: US 2012/0326404 A1
(43) Pub. Date: Dec. 27, 2012

(54) Rollable and Slideable Utility Mat and Creeper

(76) Inventor: Rick Row, Santa Rosa, CA (US)

(21) Appl. No.: 13/167,308

(22) Filed: Jun. 23, 2011

(51) Int. Cl. B62B 11/00

(52) U.S. Cl. 280/18

(57) ABSTRACT

A method of simulating a rollable and slideable utility mat and creeper for mechanics servicing a vehicle spaced from a floor provides a sheet of flexible and hardened material with a lower surface for contacting the floor and with a parallel upper surface. Said method allows said mat and creeper to allow user to access areas that are close to floor, including but not limited to the undercarriage of a low-slung automobile. Said lower surface of said mat and creeper has a lower friction than the sheet at its upper surface so that a user may adhere to said upper surface and then slide said lower surface along the floor or ground. Said mat and creeper is rollable in order to promote storage before and after use.

### FIELD OF THE INVENTION

The subject invention relates to a rollable and slideable utility mat and creeper to allow users to access cramped and low-slung areas, including but not limited to the undercarriage of a low-slung automobile.

### BACKGROUND OF THE INVENTION

Utility mats and creepers are widely used by industrial workers, do-it-yourself (DIY) hobbyists and mechanics. One definition for a creeper by Random House Dictionary, Second Edition (1987), is “a flat framework on casters, on which a mechanic lies while working under an automobile or the like.”

U.S. Pat. No. 1,764,756 (Slee, 1928) expressly incorporated herein by reference. specifically relates to a caster-less creeper comprised of a broad flat body portion adapted to slide when in use, and a head rest with rigid be extension for engagement by the body of the user to advance the same on the floor. The existing art is employs a fiber upper deck with upwardly projecting side guards and is constructed largely of cellular board having corrugations disposed for draining water or oil out of the structure on which it fell. Slee does not teach a rollable creeper and mat as is taught by the present invention. Slee does not teach a rollable creeper and mat that combines a top surface and a bottom surface in which said bottom surface has a lower friction than said top surface, as is taught by the present invention.

U.S. Pat. No. 5,419,945 (Lopez. 1995) expressly incorporated herein by reference, specifically relates to a caster-less creeper and oil and grease drip catching mat comprised of an upper and lower surface, in which a user is indicated to slide upon top surface of an oil catching mat, while said lower surface is indicated to adhere to the floor. Lopez does not teach a rollable creeper and mat as is taught by the present invention. Lopez does not teach a rollable creeper and mat that combines a top surface and a bottom surface in which said bottom surface has a lower friction than said top surface, as is taught by the present invention.

U.S. Pat. No. 4,889,352 (Chamberlin, Jr. et al, 1989) expressly incorporated herein by reference, specifically relates to a foldable mechanic's creeper with casters and hinges. Chamberlin does not teach a rollable creeper and mat as is taught by the present invention. Chamberlin does not teach a rollable creeper and mat that combines a top surface and a bottom surface in which said bottom surface has a lower friction than said top surface, as is taught by the present invention.

U.S. Pat. No. 1,451,858 (Zengerle, 1922) expressly incorporated herein by reference, specifically relates to a foldable cradle that resembles a mechanic's creeper with casters and hinges. Zengerle does not teach a rollable creeper and mat as is taught by the present invention. Zengerle does not teach a rollable creeper and mat that combines a top surface and a bottom surface in which said bottom surface has a lower friction than said top surface, as is taught by the present invention.

Today, it is necessary for Industrial, Commercial and Home users (ICAHUs) to work safely and efficiently. A need exists for a low-profile, rollable and slideable utility mat and creeper. Often, a user may want to access a tight or low area, such as the undercarriage of a low-slung automobile, and a low-profile, rollable and slideable utility mat and creeper is needed. There exists no said rollable and slideable utility mat and creeper. For this reason and others, this present invention, a rollable and slideable utility mat and creeper will easily accommodate and facilitate the ability to quickly and easily access tight and low-slung areas.

Heretofore, inventors have not created and developed a rollable and slideable utility mat and creeper for use. This invention permits said ICAHUs to employ the rollable and slideable utility mat and creeper easily and efficiently.

Accordingly, existing inventions describe methods and systems for attempting to provide a rollable and slideable utility mat and creeper, but there does not appear to be an invention that possesses all the features and components of the present invention. Moreover, none of the prior an has been commercialized due to its failure to perform its intended goal. To summarize, the systems and methods of the existing inventions have one or more of these disadvantages:
Existing art is not easy-to-use and requires a complex set of moving parts and hardware that may fail.
Existing an is not rollable and therefore is not easily stored or transported.
Existing art is not rollable and is foldable and therefore results in creating cross-sections that are not flat and therefore not slideable.
Existing art is not able to creep along a floor, but instead requires the user to creep across said existing art, and therefore is not slideable.
Existing an is not rollable and is foldable and therefore folded sections create cross-sections that are not easy to work with and not rigid enough to slide with out catching and interrupting the user.
Existing art employs use of casters or wheels which will not allow said art to fold and also create art that is too tall to access low-slung and tight areas.
Existing an does not adequately perform its intended goal with efficacy, and therefore fails in its true goal, rendering said prior art unworkable with no need for commercialization.
Existing art does not adequately perform its intended goal with efficacy, and therefore requires the user to take extra steps which cost time and effort, or to discontinue use of prior art.

### SUMMARY OF THE INVENTION

The present invention relates to a rollable and slideable utility mat and creeper to allow users to access cramped and low-slung areas, including but not limited to the undercarriage of a low-slung automobile.

One object of the invention is to simulate a rollable and slideable and castor-less creeper for mechanics servicing a vehicle.

Another object of the invention is to provide a rollable utility mat and creeper that can easily roll-up for storage and transport, and then easily roll-out in preparation for use.

Another object of the invention is to provide a slideable utility mat and creeper that can easily slide across many types of surfaces including concrete, gravel, dirt and grass.

Another object of the invention is to provide a rollable and slideable utility mat and creeper that when unrolled, the downward facing surface is able to lay flat without any contours or ridges often found in folded mats, and thereby be easily slid across virtually any surface.

Another object of the invention is to provide a rollable and slideable utility mat and creeper that when unrolled, the upward facing surface is able to employ either contours and/or ridges to allow adherence to a user, in that a user can employ his or her body in order to create friction against said contours and/or ridges in order to cause said utility mat and creeper to slide across virtually any surface.

The invention teaches a lower surface for contacting the floor and a parallel upper surface for contacting the user. The lower surface has a lower surface friction compared to the upper surface and the lower surface is meant to slide across a floor or surface. The upper surface has a higher surface friction compared to the lower surface and the upper surface is meant to adhere to the body of a user, whom may cause said lower surface to slide across a floor or surface.

Moreover, the present invention is comprised of the following: A combined, rollable and slideable creeper for mechanics servicing a vehicle spaced from a floor, comprising in combination with said vehicle and said floor: a sheet of material having a lower surface contacting said floor and having an upper surface parallel to said lower surface: and on said upper surface a layer facing said vehicle and having a higher surface friction than said sheet at said lower surface. A combined and slideable creeper, wherein: said sheet at said lower surface is flat and hardened with no lines or ridges in order to promote slideability. A combined, rollable and slideable creeper, including: text printed on said upper surface. A combined, rollable and slideable creeper, wherein: said creeper is rollable in order to promote ease of storage. A combined, rollable and slideable creeper, wherein: said upper surface has contours to promote friction with body of user. A combined, rollable and slideable creeper, wherein: said upper surface has ridges to promote friction with body of user. A combined, rollable and slideable creeper, including: text printed on said lower surface. A combined, rollable and slideable utility mat for facilitating work spaced from a floor, comprising: a sheet of material having a lower surface contacting said floor and having an upper surface parallel to said lower surface: and on said upper surface a layer facing upward and having a higher surface friction than said sheet at said lower surface. A combined, rollable and slideable utility mat, wherein: said sheet at said lower surface is flat and hardened with no lines or ridges in order to promote slideability. A combined, rollable and slideable utility mat, including: text printed on said upper surface. A combined, rollable and slideable utility mat, wherein: said utility mat is rollable to promote ease of storage. A combined, rollable and slideable utility mat, wherein: said upper surface has contours to promote friction with body of user. A combined, rollable and slideable utility mat, wherein: said upper surface has ridges to promote friction with body of user. A combined, rollable and slideable utility mat, including: text printed on said lower surface.

This present invention will be described further in preferred embodiments, and it overcomes all of the above-mentioned disadvantages of today's existing art. This invention allows users of a utility mat and creeper to access cramped and low-slung areas easily and to cause said mat and creeper to slide with accuracy and precision, and without the use of a complex series of mechanical parts.

Accordingly, a feature and advantage of this present invention is its ability to allow a user to cause said utility mat and creeper to slide, efficiently and without wasting time or effort. In other terms, this present invention assures a novel and unobvious set of features that comprises a device that may be used with ease and efficacy without adding additional work to the already arduous process of performing several tasks in cramped or low slung areas.

Various aspects, features, sub-methods, and advantages of the present invention will become more apparent from the detailed description, taken with the accompanying drawing, of preferred embodiments of the invention, which is presented for example only.

### BRIEF DESCRIPTION OF THE DRAWINGS

FIG. 1 is a drawing depicting the Rollable and Slideable Utility Mat and Creeper of the preferred embodiment.

FIG. 2 is a drawing depicting a mode of the Rollable and Slideable Utility Mat and Creeper of the preferred embodiment.

FIG. 3 is a drawing depicting a mode of the Rollable and Slideable Utility Mat and Creeper of the preferred embodiment.

### DETAILED DESCRIPTION OF THE PREFERRED EMBODIMENTS

The preferred embodiment of the present invention will now be described in even greater detail by reference to the following figures.

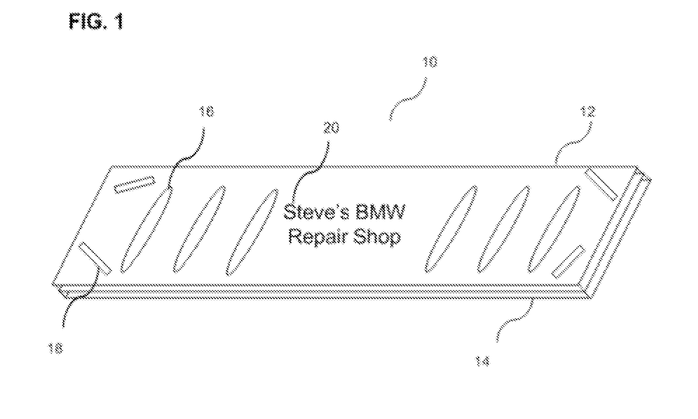

FIG. 1 depicts the Rollable and Slideable Utility Mat and Creeper 10. Said Rollable and Slideable Utility Mat and Creeper (RSUMC) 10 is comprised of a top layer 12 that typically laces upward and a bottom layer 14 that is designed to slide along a floor, ground or other surface. Gravity and weight of a user will pull and push said bottom layer 14 downward and therefore the slideability of the bottom layer 10 surface is crucial. Said bottom layer 10 does not contain any folds or indents, contours or ridges. Said top layer 12 of RSUMC 10 may contain ridges 18 that may resemble upward protrusions or bumps. Said top layer 12 of RSUMC 10 may contain contours 16 that may resemble downward indents or concave areas. Artwork, Text, designs, lettering, numbers or logos or other information 20 may be placed on either said top layer 12 and/or said bottom layer 14.

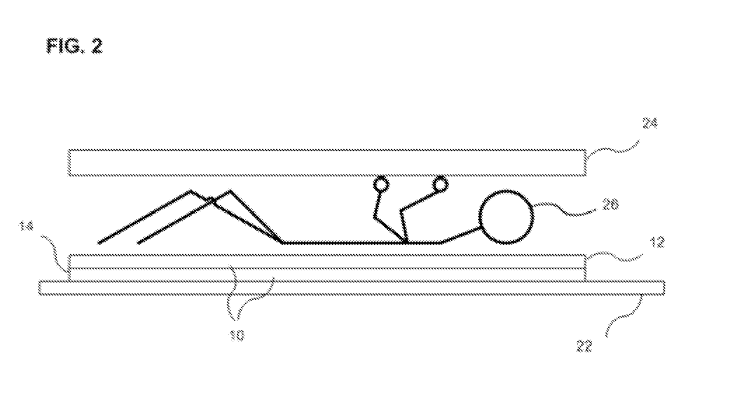

FIG. 2 depicts the Rollable and Slideable Utility Mat and Creeper 10 while in use by a user 26. Said Rollable and Slideable Utility Mat and Creeper (RSUMC) 10 is comprised of said top layer 12, said bottom layer 14, and is positioned to rest on a floor, ground or other surface 22. In this figure, said user 26 has entered a cramped space between an object 24 and a floor 22. Said user 26 may employ his or her legs or other parts of body to slide said Rollable and Slideable Utility Mat and Creeper (RSUMC) 10 across said floor 22.

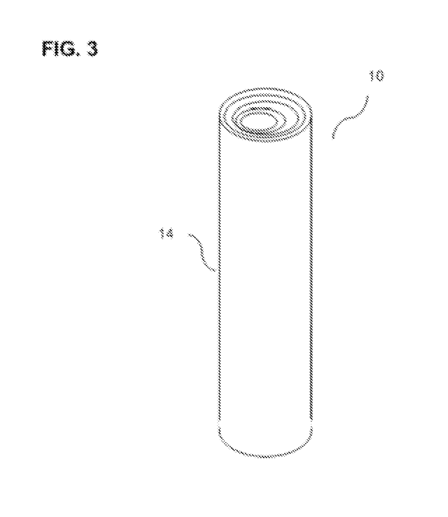

FIG. 3 depicts the Rollable and Slideable Utility Mat and Creeper 10 in rolled-up position. Said Rollable and Slideable Utility Mat and Creeper (RSUMC) 10 is, in this figure. rolled-up with said bottom layer 14 facing outward making it easily viewable. In this case, said Rollable and Slideable Utility Mat and Creeper (RSUMC) 10 is easily transportable and storable.

What is claimed is:

1. A combined rollable and slideable creeper for mechanics servicing a vehicle spaced from a floor, comprising in combination with said vehicle and said floor:
a sheet of material having a lower surface contacting said floor and having an upper surface parallel to said lower surface, and
on said upper surface a layer facing said vehicle and having a higher surface friction than said sheet at said lower surface.

2. A combined and slideable creeper as in claim 1, wherein:
said sheet at said lower surface is flat and hardened with no lines or ridges in order to promote slideability.

3. A combined, reliable and slideable creeper as in claim 1, including:
text or information printed on said upper surface.

4. A combined, rollable and slideable creeper as in claim 1, wherein:
said creeper is rollable in order to promote ease of storage.

5. A combined, rollable and slideable creeper as in claim 1, wherein:
said upper surface has contours to promote friction with body of user.

6. A combined. rollable and slideable creeper as in claim 1, wherein:
said upper surface has ridges to promote friction with body of user.

7. A combined, rollable and slideable creeper as in claim 1, including:
text or information printed on said lower surface.

8. A combined, rollable and slideable utility mat for facilitating work spaced from a floor, comprising:
a sheet of material having a lower surface contacting said floor and having an upper surface parallel to said lower surface; and
on said upper surface a layer facing upward and having a higher surface friction than said sheet at said lower surface.

9. A combined, rollable and slideable utility mat as in claim 8, wherein:
said sheet at said lower surface is flat and hardened with no lines or ridges in order to promote slideability.

10. A combined, rollable and slideable utility mat as in claim 8, including:
text or information printed on said upper surface.

11. A combined, rollable and slideable utility mat as in claim 8, wherein:
said utility mat is rollable to promote ease of storage.

12. A combined, rollable and slideable utility mat as in claim 8, wherein:
said upper surface has contours to promote friction with body of user.

13. A combined, rollable and slideable utility mat as in claim 8, wherein:
said upper surface has ridges to promote friction with body of user.

14. A combined, rollable and slideable utility mat as in claim 8, including:
text or information printed on said lower surface.
